(19) United States
(12) Patent Application Publication
(10) Pub. No.: US 2015/0039815 A1
(43) Pub. Date: Feb. 5, 2015

(54) SYSTEM AND METHOD FOR INTERFACING BETWEEN STORAGE DEVICE AND HOST

(71) Applicant: OCZ Storage Solutions Inc., San Jose, CA (US)

(72) Inventor: Yaron Klein, Raanana (IL)

(21) Appl. No.: 14/451,266

(22) Filed: Aug. 4, 2014

Related U.S. Application Data
(60) Provisional application No. 61/861,590, filed on Aug. 2, 2013.

(51) Int. Cl. G06F 12/02; G06F 3/06

(52) U.S. Cl. CPC G06F 12/0246; G06F 3/0604; G06F 3/0659; G06F 3/0679
USPC 711/103

(57) ABSTRACT

A system and method of use thereof that include a mass storage device connected to a host computer running host software modules. The mass storage device includes at least one non-volatile memory device, at least one volatile memory device, and a memory controller attached to the non-volatile and volatile memory devices wherein the memory controller is connected to the host computer via a computer bus interface. Firmware executing on the memory controller provides software primitive functions, a software protocol interface, and an application programming interface to the host computer. The host software modules run by the host computer access the software primitives functions and the application programming interface of the mass storage device.

### CROSS REFERENCE TO RELATED APPLICATIONS

This application claims the benefit of U.S. Provisional Application No. 61/861,590, filed Aug. 2, 2013, the contents of which are incorporated herein by reference.

### BACKGROUND OF THE INVENTION

The present invention generally relates to solid-state mass storage media and their use and operation. More particularly, the present invention relates to systems and methods for interfacing between host systems and solid-state mass storage devices of solid-state storage drives, wherein the drives are configured to implement server storage or storage appliance software functionality.

Non-volatile solid-state memory technologies used with computers and other processing apparatuses (host systems) are currently largely focused on NAND flash memory technologies, with other emerging non-volatile solid-state memory technologies including phase change memory (PCM), resistive random access memory (RRAM), magnetoresistive random access memory (MRAM), ferromagnetic random access memory (FRAM), organic memories, and nanotechnology based storage media such as carbon nanofiber/nanotube-based substrates. These and other non-volatile solid-state memory technologies will be collectively referred to herein as solid-state mass storage media. Mainly for cost reasons, at present the most common solid-state memory technology used in solid-state drives (SSDs) are NAND flash memory components, commonly referred to as flash-based memory devices, flash-based storage devices, flash-based media, or raw flash.

Similar to rotating media-based hard disk drives (HDDs), SSDs utilize a type of non-volatile memory media and therefore provide persistent data storage (persistency) without application of power. In comparison to HDDs, SSDs can service a READ command in a quasi-immediate operation, yielding much higher performance especially in the case of small random access read commands. This is largely due to the fact that flash-based storage devices (as well as other non-volatile solid-state mass storage media) used in SSDs are purely electronic devices that do not contain any moving parts. In addition, multi-channel architectures of modern NAND flash-based SSDs result in sequential data transfers saturating most host interfaces. A specialized case is the integration of an SSD into an HDD to form what is typically referred to as hybrid drive. However, even in the case of a hybrid drive, the integrated SSD is functionally equivalent to any stand-alone SSD.

Another difference between HDDs and flash-based SSDs relates to the write endurance of flash-based media. Briefly, flash-based memory components store information in an array of floating-gate transistors, referred to as cells. NAND flash memory cells are organized in what are commonly referred to as pages, which in turn are organized in predetermined sections of the component referred to as memory blocks (or sectors). Each cell of a NAND flash memory component has a top gate (TG) and a floating gate (FG), the latter being sandwiched between the top gate and the channel of the cell. The floating gate is separated from the channel by an oxide layer, often referred to as the tunnel oxide. Data are stored in a NAND flash memory cell in the form of a charge on the floating gate which, in turn, defines the channel properties of the NAND flash memory cell by either augmenting or opposing the charge of the top gate. This charge on the floating gate is achieved by applying a programming voltage to the top gate. The process of programming (writing 0's to) a NAND cell requires injection of electrons into the floating gate by quantum mechanical tunneling, whereas the process of erasing (writing 1's to) a NAND cell requires applying an erase voltage to the device substrate, which then pulls electrons from the floating gate. Programming and erasing NAND flash memory cells is an extremely harsh process utilizing strong electrical fields to move electrons through the oxide layer. After multiple writes to a flash memory cell, it will inadvertently suffer from write endurance problems caused by the breakdown of the oxide layer. With smaller process geometries becoming more prevalent, write endurance problems are becoming increasingly important.

Another difference between HDDs and NAND flash memory technology relates to data retention, that is, the maximum time after which data are written that the information is still guaranteed to be valid and correct. Whereas HDDs retain data for a practically unlimited period of time, NAND flash memory cells are subjected to leakage currents that cause the programming charge to dissipate and hence result in data loss. Retention time for NAND flash memory may vary between different levels of reliability, for example, about five years in an enterprise environment to about one to three years in consumer products. Retention problems are also becoming increasingly important with smaller process geometries.

Strong error correction, such as through the use of error checking and correction (ECC) algorithms, can be applied to reduce errors over time. With decreasing process geometries, constant data scrubbing is required to counteract increasing failure rates associated with retention. As known in the art, scrubbing generally refers to refreshing data by reading data from a memory component, correcting any errors, then writing the data back, usually to a different physical location within the memory component.

Flash-based SSDs have been utilized as replacements for HDDs in servers and storage appliances, often providing immediate performance gains. For example, applications that utilize high input/output (I/O) operation workloads with random patterns can benefit from flash media advantages, including reduced random access times and increased data transfer throughput. However, using flash-based SSDs as mass storage devices alone may not provide a major advantage over HDDs in every situation. Modern applications such as in-memory applications process most of their information in the host's volatile memory space and use a mass storage device as a temporary space to load large portions of information to the volatile memory space. Thus, the host workload toward the mass storage device may comprise more bulk reads than random input/output operations, reducing the advantages of flash-based SSDs.

Modern operating systems may also require more functionality from mass storage devices by offloading management functions toward the storage devices. Nonlimiting examples include functionalities conventionally handled by a host that utilize heavily persistent metadata management, such as journaling, replication, and volume snapshots. Microsoft® VSS (Volume Shadow Copy) takes snapshots of volumes within a mass storage device by causing the operating system to stall an application's operation and call on the storage device to take a snapshot of the volumes. Conventionally, a snapshot operation requires heavy persistent metadata management (i.e., metadata residing on persistent media) utilizing the host's resources. Offloading such functionality to a mass storage device releases the host's resources and is therefore more efficient than managing the operation in the host.

U.S. Pat. No. 8,200,922 discloses an approach of implementing internal snapshots in an SSD device. U.S. Patent Application No. 2013/205,492 addresses endurance issues caused by offloading metadata workload to a mass storage device, together with the IO enhancement of the snapshot operation via flash management improvements. By leveraging the Flash Translation Layer (FTL) to support Copy On Write (COW) internally, some overhead from the host is saved. However, these approaches lack a systemwide approach and instead propose a closed system (i.e., an SSD) with internal capabilities. VMware® Virtual Volumes (vVol) is another example by which snapshot operations can be offloaded to a mass storage device. Virtual Volumes provides volume information via an Object Storage protocol to a mass storage device, enabling the storage device to handle snapshot directives in Virtual Volume granularity.

Another example of offloading storage functionality is an application program interface (API) framework commercially available from VMware® under the name Virtual APIs for Array Integration (VAAI). VAAI is described as comprising a number of parts or features referred to as primitives that can perform a function on a mass storage device or request that a function be performed on the storage device. As an example, a copy primitive is used for virtual volume cloning and implies storage stack usage (i.e., servers, networking components, and server virtualization software). By offloading this functionality to a mass storage device, the copy operation is done internally and frees the host's resources. Similarly, a reset primitive is used to set zeroes in a data segment by the storage device, again releasing the host's resources.

The functionality of such primitives is implemented not only in storage appliances, but also in modern file systems. For example, B-Tree File System (BTRFS) provides snapshot and journal capabilities, implemented in the file system level, i.e., by the host's resources.

It would be desirable to provide more systemwide approaches to providing storage functionality (for example, snapshots, journaling, VAAI, etc.) that are capable of integrating multiple levels (for example, hardware, firmware, software, etc.) of the data path within a system (for example, a server, storage appliance, etc.) in a plurality of environments (for example, mass storage devices, controllers, host, etc.) of the system, particularly if such a systemwide approach could be optimized to leverage the strength of each environment and provide synergy between the various elements within the system.

### BRIEF DESCRIPTION OF THE INVENTION

The present invention provides systems and methods capable of implementing one or more storage functionalities with a mass storage device, in particular, a flash-based SSD in a host system by utilizing hardware and firmware elements of the SSD and software components executed by the host system.

According to one aspect of the invention, a system includes a mass storage device connected to a host computer running host software modules. The mass storage device includes at least one non-volatile memory device, at least one volatile memory device, and a memory controller attached to the non-volatile and volatile memory devices wherein the memory controller is connected to the host computer via a computer bus interface. Firmware executing on the memory controller provides software primitive functions, a software protocol interface, and an application programming interface to the host computer. The host software modules run by the host computer access the software primitives functions and the application programming interface of the mass storage device.

According to another aspect of the invention, a method performed with a system comprising a mass storage device connected to a host computer running host software modules, the mass storage device including at least one non-volatile memory device, at least one volatile memory device, and a memory controller attached to the non-volatile and volatile memory devices wherein the memory controller being connected to the host computer via a computer bus interface. The method includes executing firmware on the memory controller to provide software primitive functions, a software protocol interface, and an application programming interface to the host computer and running the host software modules to access the software primitives functions and the application programming interface of the mass storage device.

A technical effect of the invention is the ability to implement server and storage appliance functionality in a flash-based SSD or another efficient, solid-state mass storage device. In particular, it is believed that server or storage application functionality can be more efficiently performed by implementing the functions on a solid-state mass storage device having software primitive functions accessible by software modules of a host computer such that server or storage application functions are processed by the mass storage device, thereby reducing the workload on the host computer.

Other aspects and advantages of this invention will be further appreciated from the accompanying drawings and the following detailed description.

### BRIEF DESCRIPTION OF THE DRAWINGS

FIG. 1 is a block diagram that represents a system comprising software applications, hardware that includes firmware and a flash-based memory component, and a unit for performing functions on the hardware in accordance with an aspect of the invention.

FIG. 2 is a block diagram that represents the flash-based memory component of FIG. 1 utilized for metadata management in accordance with an aspect of the invention.

FIG. 3 is a block diagram that represents firmware primitives in accordance with an aspect of the invention.

FIG. 4 is a block diagram that represents snapshot implementation using firmware primitives and hardware components in accordance with an aspect of the invention.

FIG. 5 is a block diagram that represents a copy on write implementation of a snapshot functionality in accordance with an aspect of the invention.

FIG. 6 is a block diagram that represents journal functionality using firmware primitives and hardware components in accordance with an aspect of the invention.

FIG. 7 is a block diagram that represents journal implementation via change repository in accordance with an aspect of the invention.

FIG. 8 is a block diagram that represents object creation implementation using firmware primitives and hardware components in accordance with an aspect of the invention.

FIG. 9 is a block diagram that represents object clone implementation using firmware primitives and hardware components in accordance with an aspect of the invention.

### DETAILED DESCRIPTION OF THE INVENTION

The embodiments disclosed herein are nonlimiting examples of various possible advantageous uses and implementations of systems and methods capable of implementing one or more storage functionalities with a mass storage device in a host system by utilizing hardware and firmware elements of the mass storage device and software components executed by the host system. In general, statements herein may apply to some features or embodiments but not to others. Unless otherwise indicated, singular elements may be in plural and vice-versa with no loss of generality. In the drawings, like numerals refer to like parts through the several views.

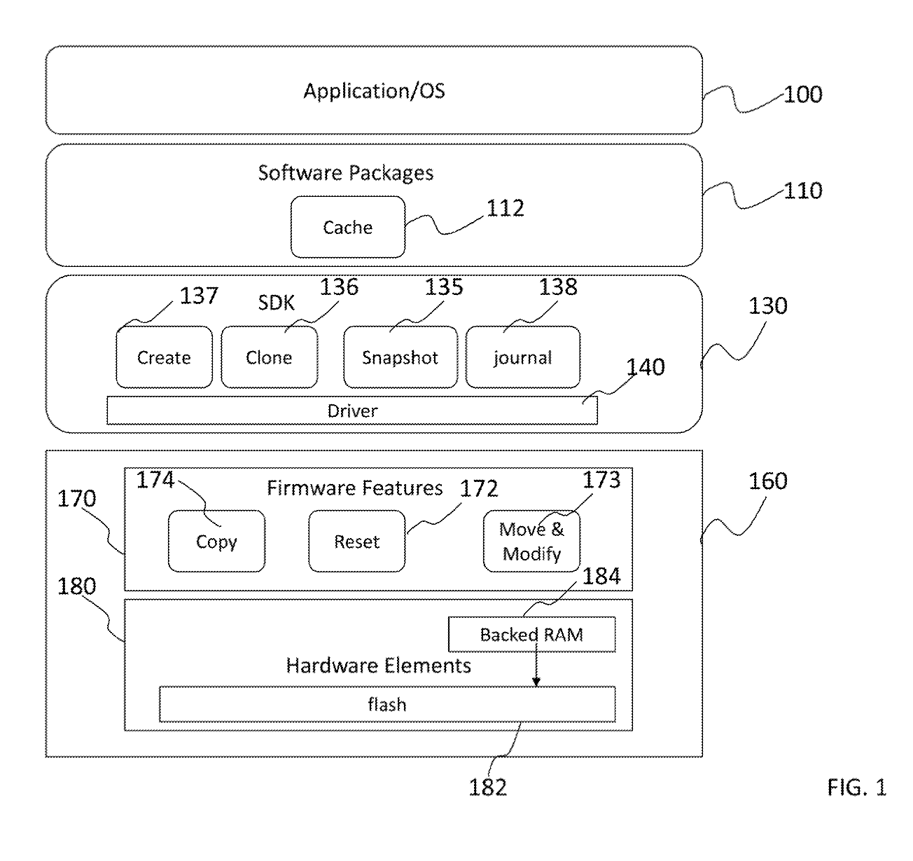

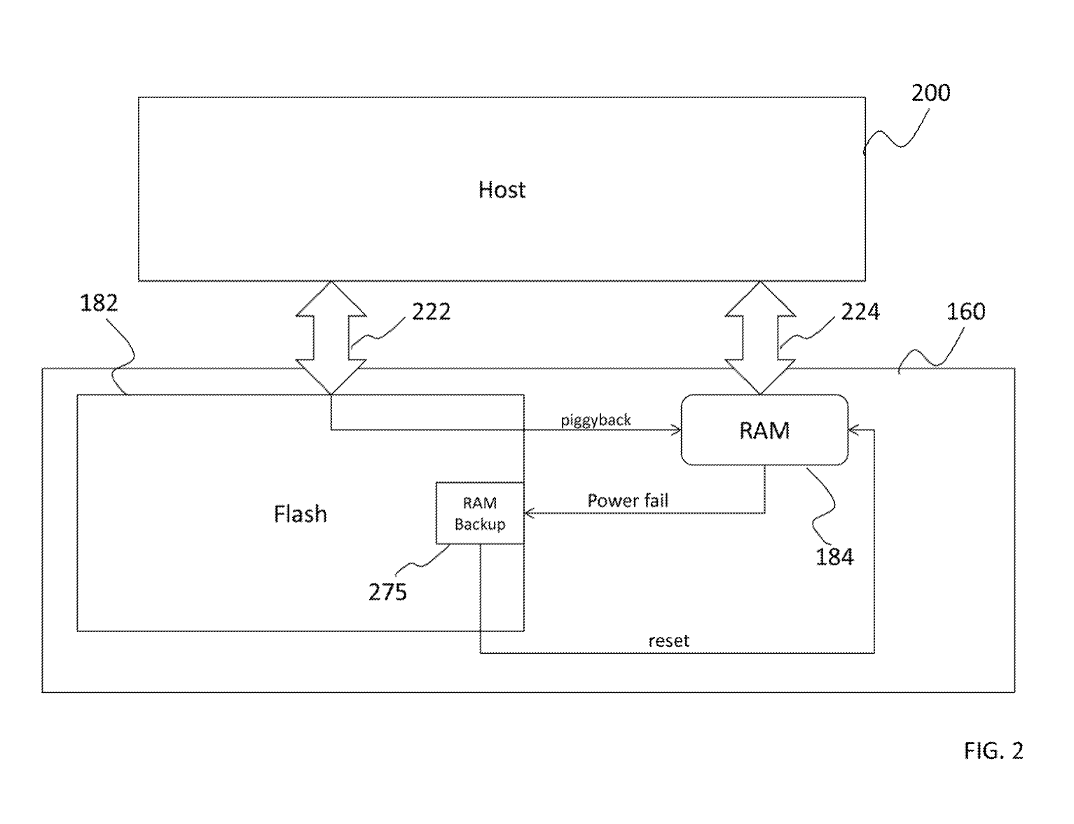

FIG. 1 shows an exemplary and non-limiting diagram of a system or storage stack (i.e., a “stack” of software and hardware components in a computer storage subsystem) that utilizes elements of hardware, firmware, and software for efficient implementation of server or appliance functionality. The system is represented in FIG. 1 as including a mass storage device 160 (for example, a solid-state drive, SSD) that includes at least one hardware component 180 comprising one or more flash-based hardware elements 182 (or other solid-state memory devices) and firmware (controller software) 170 stored on a memory controller (not shown), which can be connected to a host system (200 in FIG. 2) via a computer bus interface (not shown). The firmware 170 includes firmware features, referred to herein as operations or primitives, which refer to parts or features of an application programming interface (API) framework that can perform a function on the hardware elements 182 (or other solid-state memory devices) or request that a function be performed on the hardware elements 182. Nonlimiting examples of such functions include a “reset” operation (primitive) 172, “move and modify” operation (primitive) 173, and “copy” operation (primitive) 174. The system represented in FIG. 1 is shown as further including applications/OS 100, software packages 110, and software modules 135-138 of the host system 200. The software modules 135-138 may reside in a software development kit (SDK) 130 of the host system 200. The software modules 135-138 may include, but are not limited to, code implementations of high level functions such as snapshot management, object storage management (e.g., clone and create), and journal management.

In addition to the flash-based hardware elements 182, the hardware component 180 is shown as including flash-backed memory 184, for example, a random access memory (RAM) component such as dynamic random access memory (DRAM) that, in a case of power failure, is written to the hardware elements 182 (i.e., backed up in non-volatile storage). Power failure can be detected by various conventional methods and data backup can be assured via components, for example, super-capacitors, batteries, etc., that maintain power for the backup process.

The firmware 170 of the storage device 160 controls the API to a host system 200, for example, a host server or appliance. The firmware 170 parses commands from the host system 200 and performs them on the hardware component 180. The commands from the host system 200 can be standard commands, for example, standard SCSI commands, standard NVM-e commands, or vendor specific commands. Such commands may include the aforementioned reset primitive 172 (similar to SCSI WRITE SAME command), move and modify primitive 173 (which moves data from a source location to a destination location and then writes to the source location), and copy primitive 174 (similar to the SCSI XCOPY command). Because these operations are performed on the hardware elements 182, they are referred to herein as primitives.

The SDK 130, which as used herein broadly encompasses programming software packages that may include one or more APIs, programming tools, etc., and enable a programmer to develop applications for a specific platform. Typically an SDK, may include several independent software modules that can be integrated with a user's environment. In FIG. 1, the SDK 130 includes a driver 140 for the storage device 160, along with individual modules 135-138 for each of the snapshot, object storage, and journal management functions.

The software packages 110 may be capable of optimizing the usage of the above components. For example, a general caching software 112 can be used for further acceleration of the system.

The above components provide a systemwide solution that can be integrated with the application/OS 100 (or other appliance) of the host system 200 to provide server or appliance functionality that optimizes hardware resources.

Usage of flash-based memory technologies for persistent metadata management is believed to be problematic due to several reasons. Metadata management applies a massive amount of data manipulations that are translated in a flash-based memory device to a massive amount of program-erase (P/E) cycles. Due to the limited endurance of flash-based memory, the reliability of the memory decreases as the number of P/E cycles performed therein increases. Furthermore, flash-based memory granularity is page wide (typically 8 K bytes). That is, manipulation of one byte requires programming of an 8 K byte page. Hence, the duration of the operation extends considerably. By comparison, the granularity and latency of RAM manipulation is much smaller (for example, one word; wherein a word is the number of digits a CPU can process at one time) and much faster than in flash-based memory. Consequently, RAM is believed to be better suited for the data granularity, workload, and performance required for metadata manipulation than flash-based memory.

FIG. 2 shows a block diagram representing the host system 200 functionally connected to the storage device 160, which includes at least two types of memory media including the non-volatile hardware elements 182 and the volatile flash-backed memory 184. According to a nonlimiting aspect of the invention, the flash-backed memory 184 in the hardware component 180 may be used to maintain and manage persistent metadata (or any other persistent information) for the host system 200. In the event of a power failure, data stored in the flash-backed memory 184 is written to a dedicated backup area 275 in the hardware elements 182. Upon power-up (after reset) the data are restored from the dedicated backup area 275 in the hardware elements 182 to the flash-backed memory 184 prior to other operations.

According to a nonlimiting aspect of the invention, the host system 200 can access the flash-backed memory 184 via standard READ BUFFER (code 0x3C) and WRITE BUFFER SCSI (code 0x3B) commands thereby having a direct path 224 to the flash-backed memory 184. According to another nonlimiting aspect of the invention, the host system 200 can access the flash-backed memory 184 via SCSI vendor specific commands allowing Scatter Gather List (SGL) writing to the flash-backed memory 184 in a single input/output operation (or a single SCSI cycle).

Yet another nonlimiting aspect of the invention is that data can be written to the flash-backed memory 184 via data transfer piggybacking on an SCSI Write command. As used herein, data transfer piggybacking refers to the inclusion of metadata along with data when transferring the data. Hence, via a single input/output operation both the flash-backed memory 184 (metadata space) and the hardware elements 182 (data space) may be updated. This may be accomplished with a vendor specific command which pairs SCSI Write Command and RAM Write.

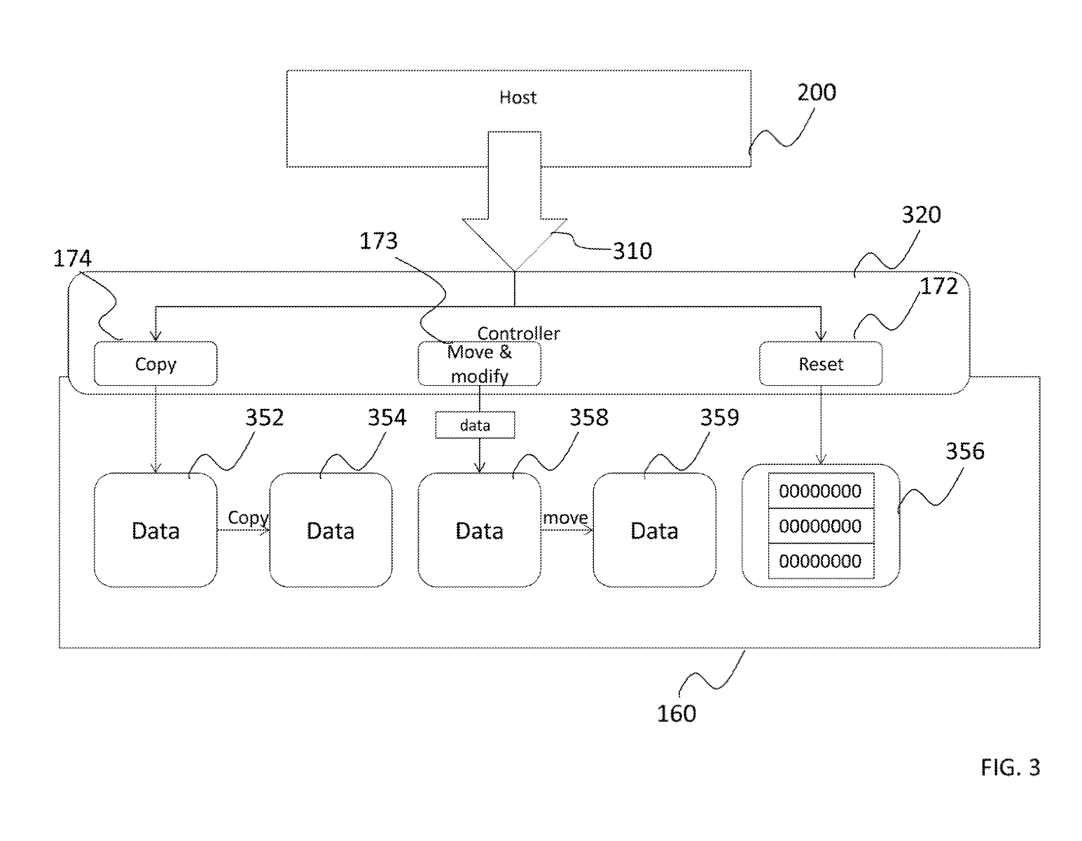

As shown in FIG. 3, the storage device 160 may include a controller 320 on which is stored the firmware 170 that implements (beside the regular read and write directives) extra primitives, including the aforementioned reset primitive 172, move and modify primitive 173, and copy primitive 174 received from the host system 200 via a path 310. According to a nonlimiting aspect of the invention, the copy primitive 174 in the firmware 170 copies data from a first area 352 in memory (hardware elements 182 or flash-backed memory 184) of the storage device 160 to a second area 354 in the memory 182 or 184 of the storage device 160. The host system 200 sends the copy primitive 174 with a source logical block address (LBA), a destination LBA, and a length of the data. After the copying process is completed, the host system 200 receives an acknowledgment from the controller 320 indicating that the data were copied successfully. The copy primitive 174 may be an implementation of the SCSI command Extended copy (command 0x83), and a vendor specific command may couple the copy primitive 174 with writing to the flash-backed memory 184.

According to another nonlimiting aspect of the invention, the reset primitive 172 in the firmware 170 sets a fixed value (such as zero) to an area 356 in the memory 182 or 184 of the storage device 160. The host system 200 sends the reset primitive 172 with a source LBA, a length of the area 356, and a fixed value. This fixed value is set in all locations of the area 356. The host system 200 receives an acknowledgment when the process is completed by the controller 320. The reset primitive 325 may be an implementation of the SCSI command Write Same (command 0x41).

According to another nonlimiting aspect of the invention, the move and modify primitive 173 moves a data segment from a first area 358 in the memory 182 or 184 of the storage device 160 to a second area 359 in the memory 182 or 184 of the storage device 160 and then writes data to the first area 358. The host system 200 sends the move and modify primitive 173 with a source LBA, a destination LBA, and a data segment. The controller 320 moves data from the source LBA to the destination LBA and then writes the attached data segment to the source LBA. According to nonlimiting aspects of the invention, the move and modify primitive 173 can be activated via a SCSI vendor specific command, and/or the controller 320 can implement a “move part” in the command via mapping change of the Flash Translation Layer (FTL). As a result, the “move part” in the command can be executed without an input/output operation. A vendor specific command may couple the move and modify primitive 173 with writing to the flash-backed memory 184.

According to a nonlimiting aspect of the invention, the host system 200 can access the primitives 172, 173 and 174 via the driver 140 in the host system 200. The driver 140 may implement a protocol API, such as SCSI, NVM-e, etc., to the host system 200 or a storage stack of the host system 200.

According to a nonlimiting aspect of the invention, complementary software, such as the software packages 110, in the host system can provide higher level of functionality by using the underlying elements within the system, such as the hardware component 180 and firmware 170.

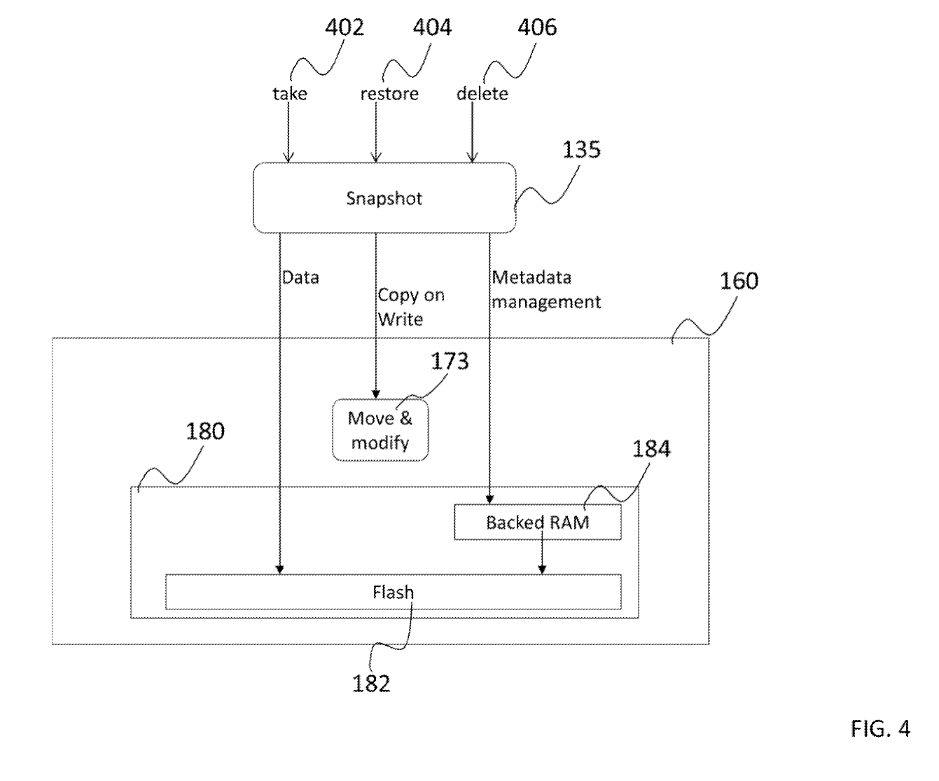

As represented in FIG. 4, the “snapshot” module 135 may implement snapshot functionality via the firmware primitives 172, 173 and 174 and hardware component 180. Such snapshot functionality can be integrated to a host system, for example, Microsoft® VSS, VMware® snapshot, BTRFS file system, etc. The snapshot module 135 can also be integrated with storage appliance software to provide better implementation of its snapshot functionality. According to a nonlimiting aspect of the invention, the snapshot module 135 can provide standard API comprising “take snapshot” 402, “restore from snapshot” 404 and “delete a snapshot” 406 functions. According to another nonlimiting aspect of the invention, the snapshot module 135 may implement Microsoft® Volume Shadow Copy Service (VSS) provider. Yet another nonlimiting aspect of the invention is for the snapshot module 135 to interact with the storage device 160 to implement the snapshot functionality. Metadata management, that is, Copy on Write tables are managed in the flash-backed memory 184 in the storage device 160. Production and snapshot data and data copied via the modify & move primitive 173 are stored in the hardware elements 182 of the storage device 160.

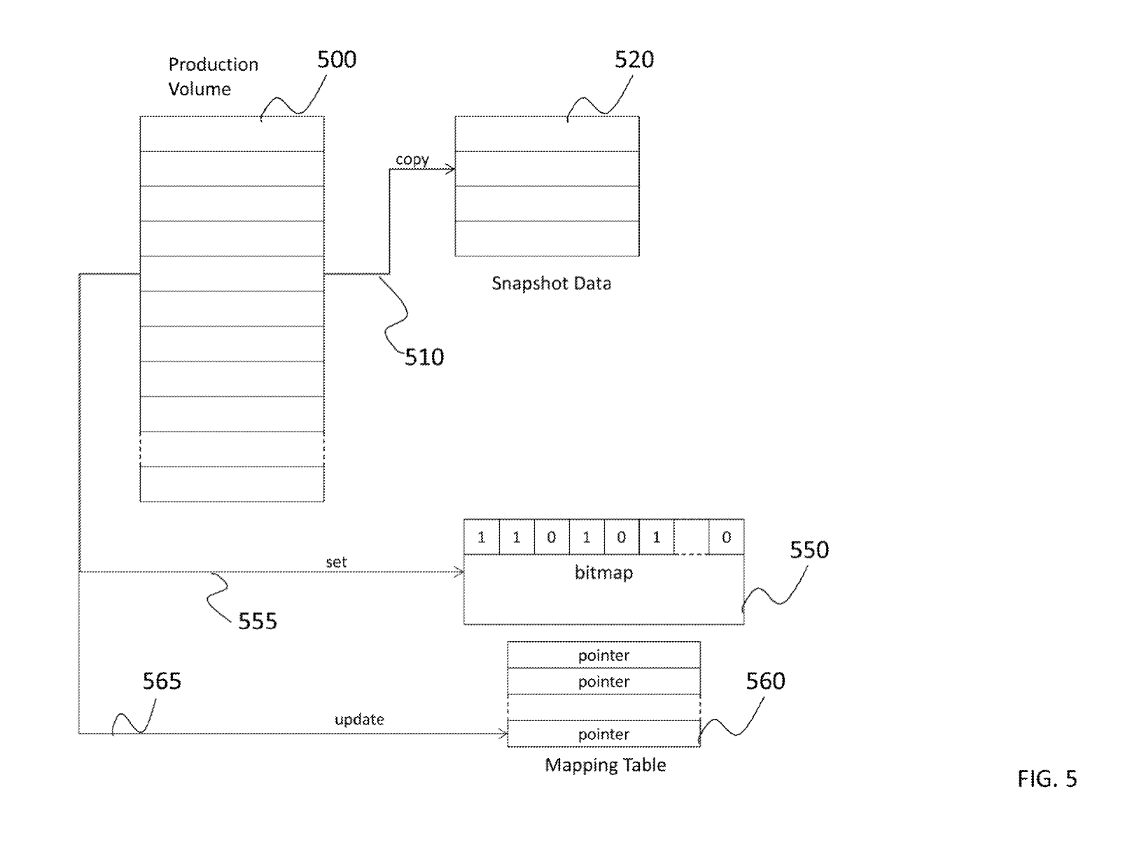

As represented in FIG. 5, a snapshot implementation via “Copy on Write” applies a production volume 500 that is segmented logically (for example, each segment may be 256 K wide). The snapshot data are placed in a dedicated snapshot data space 520 constructed from segments of the production volume 500. Snapshot metadata management includes bitmap 550 of changed segments (segments that were modified since snapshot was taken) and mapping table 560 that maps between segments in the snapshot data space 520 to the original address in the production volume 500. Every element including the production volume 500, the snapshot data space 520, and metadata (bitmap 550 and mapping table 560) is preferably persistent to enable recovery after a power failure. The host system 200 may maintain a copy of the metadata internally, that is, in a memory of the host system 200, for fast read.

When data are written to the production volume 500, the host system 200 checks the appropriate bit in the bitmap 550 (or in an internal copy of the bitmap in the host system 200). If the required data segments (segments that the required data reside on) are not modified (that is, first write to this segment), the host system 200 can read the original segment from the production volume 500, write the data 510 to the snapshot data space 520, set 555 the appropriate bit in the bitmap area 550, and update 565 the mapping table 560.

In conventional Copy on Write implementations, where metadata are stored on a storage media, every such action conventionally requires five input/output operations. Hence, conventional snapshot operations slow the system performance by a factor of five. According to a nonlimiting aspect of the invention, the snapshot module 135 is capable of implementing a “Copy on Write” snapshot with a single input/output operation.

In the case of a first write to a segment in the production volume 500, the snapshot module 135 may use the move & modify primitive 173 and piggyback an SGL with bitmap and mapping data to copy 510 a data segment from the production volume 500 to the snapshot data space 520, set new data on the production volume 500, update 565 mapping table 560, and set 555 bitmap 550 in a single input/output operation. As a result, a write operation in a snapshot state may only require a single input/output operation such that performance of the system 200 is not degraded as in conventional systems.

According to a nonlimiting aspect of the invention, if one element of the snapshot sequence fails, for example, data fails to copy 510 to the snapshot data space 520 or data fails to set in the production volume 500, the metadata will not be updated and the storage device 160 will return a fail status to the host system 200.

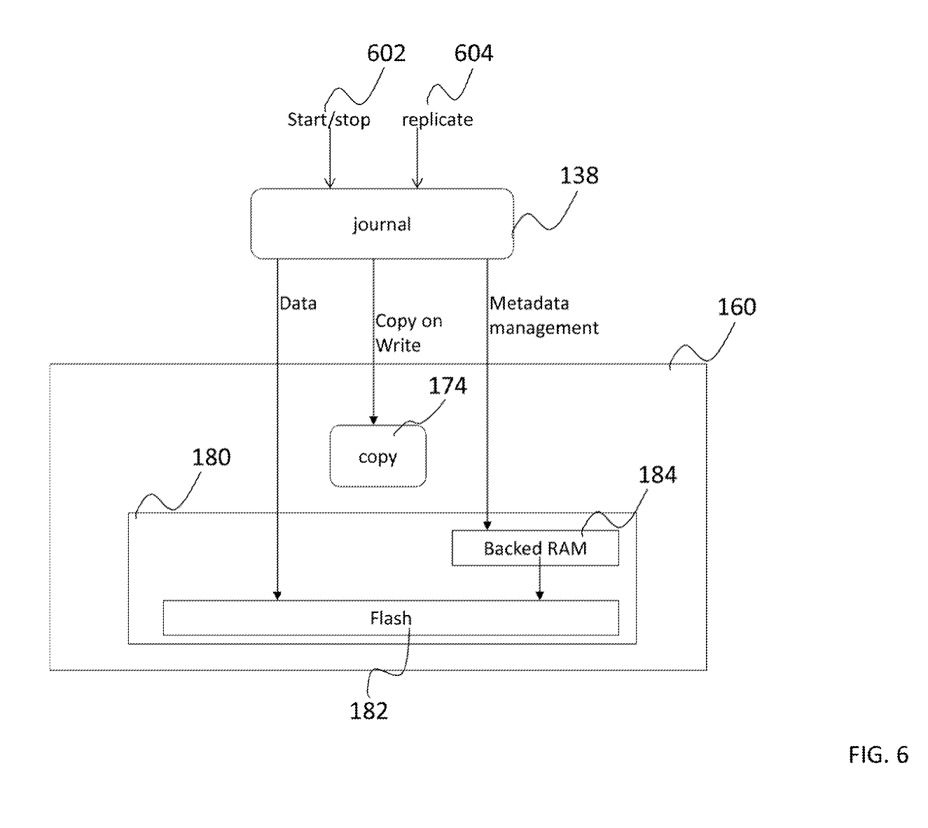

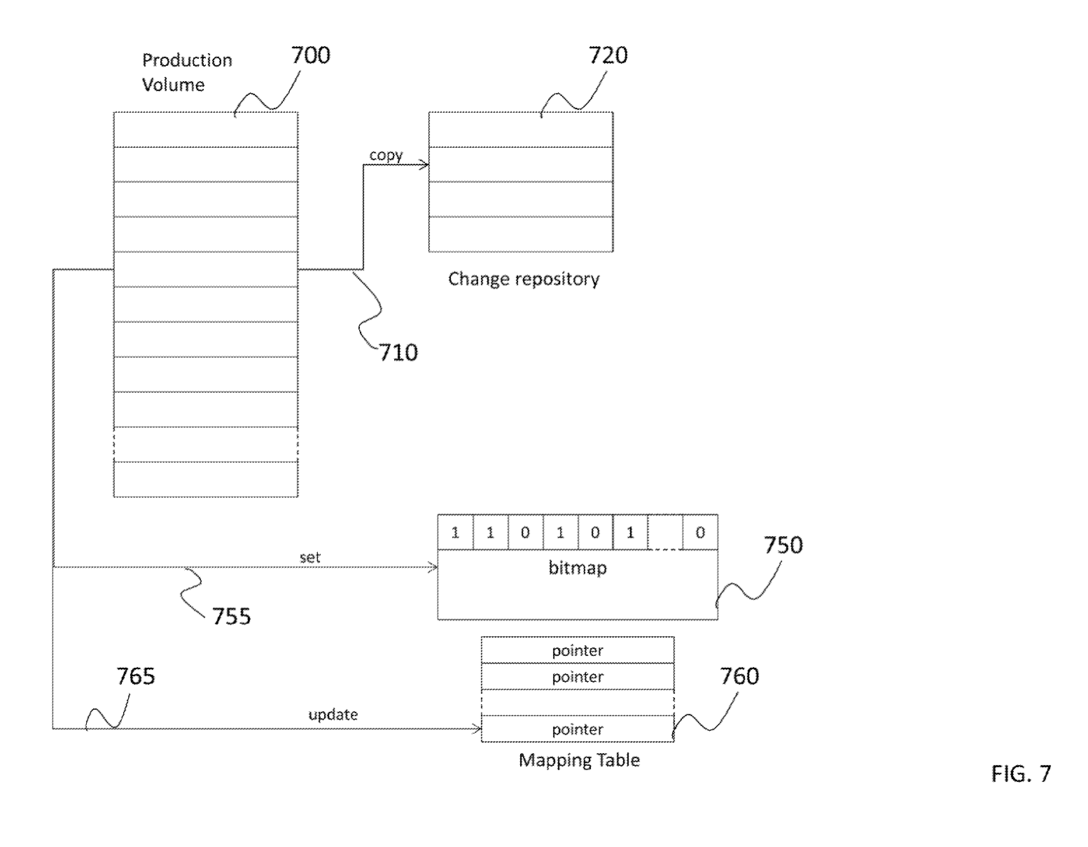

As represented in FIGS. 6 and 7, the “journal” module 138 provides a change repository 720 of a production volume 700 that can be used for asynchronous replication. The journal module 138 may provide start/stop directives 602 and a replicate directive 604. After a start directive 602 is received, the journal module 138 logs all the changes in an area of the change repository 720. When a user initiates a stop directive 602 to stop the logging, the journal module 138 can fetch the changes in the area of the change repository 720 via the replicate directive 604 and send the changes to a remote site, where the changes can be merged with a remote copy of the production volume 700.

FIG. 7 represents a journal process implemented by the journal module 138. The production volume 700 is logically divided into fixed sized segments (for example, each segment may be 256 K wide). The change repository 720 maintains segments that were modified in the production volume 700. Persistent metadata includes a bitmap 750 that marks the modified segments in the production volume 700 and a mapping table 760 that provides mapping between the segments in the change repository 720 and the production volume 700.

When data are written to the production volume 700, the corresponding data segment or segments (i.e., the segment or segments where the data reside) are modified and copied 710 to the change repository 720. If a segment is modified for the first time, the segment is added to the change repository, its corresponding bit is set 755 in the bitmap 750, and its mapping is updated 765 in the mapping table 760. If the segment was already modified previously, only new data are set in its location in the change repository 720.

As the metadata are preferably persistent to cope with a power failure, the journal process conventionally requires for every write command a write to the production volume 700, a read from the metadata, a write to the change repository 720, and a write to the metadata. Hence, every incoming write command conventionally requires four input/output operations. According to a nonlimiting aspect of the invention, the journal module 138 maintains a copy of the metadata in the host system's memory. When the journal module 138 receives a write command from the host system 200, the journal module 138 checks if the data segment is already in the change repository 720. If the data segment does not reside in the change repository 720, the journal module 138 writes the data to the production volume 700, copies 710 the modified segment from the production volume 700 to the change repository 720, sets 755 the segment's bit in the bitmap, and updates 765 the segment location in the change repository 720 to the mapping table 760. If the segment already resides in the change repository 720, the metadata does not require changes.

According to a nonlimiting aspect of the invention, the journal module 138 piggybacks the metadata information, that is, bitmap and mapping data, as an SGL to the write command. Accordingly, data are written to the production volume 700, copied 710 to the change repository 720 via the copy primitive 174, set 755 to the bitmap 750, and updated 765 to the mapping table 760 in a single input/output operation. According to a nonlimiting aspect of the invention, if one element of the journal sequence fails, for example data fails to copy 710 to the change repository 720 or data fails to set in the production volume 700, the metadata will not be updated and the flash-based device 160 will return a fail status to the host system 200.

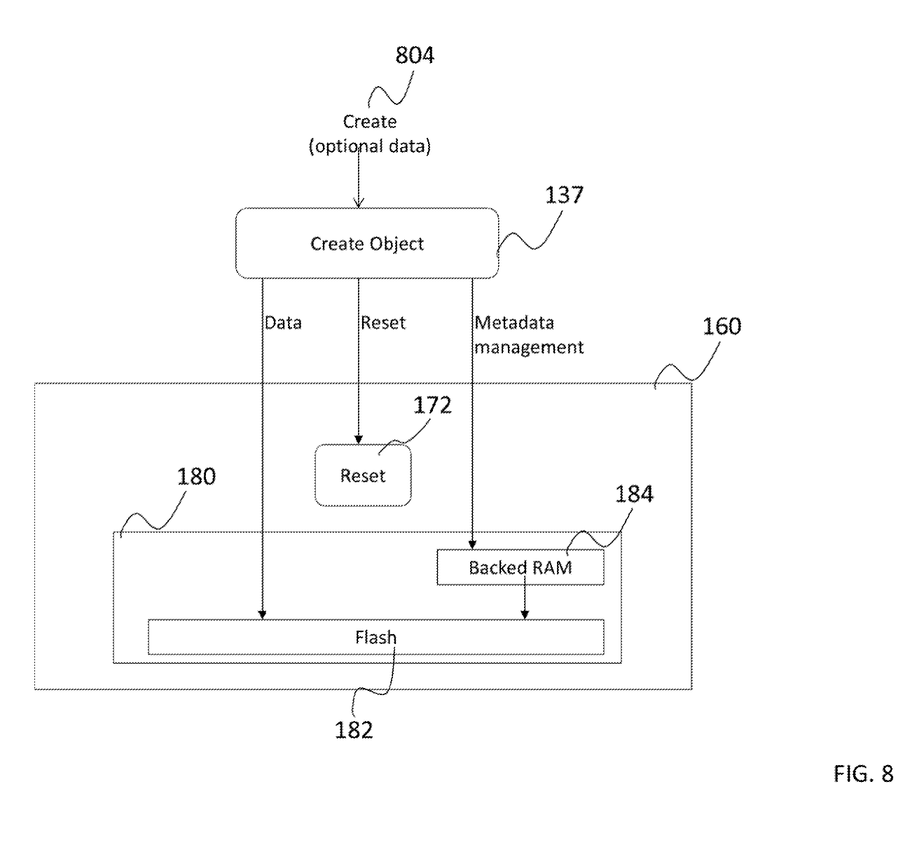

As shown in FIG. 8, the “create object” module 137 provides object creation functionality. Such functionality can be used for Virtual Machine or virtual volume functionality, object creation functionality, for example, image, video, or audio objects in an object storage device. According to a nonlimiting aspect of the invention, the create object module 137 receives a Create directive 804 from the host system 200 (with optional data). If data reset is required, such as in the case of virtual volume creation in VMware®, the create object module 137 uses the Reset primitive 172 to set zeroes in the address containing the object. According to a nonlimiting aspect of the invention, the storage device 160 can provide object management in the flash-backed memory 184 (via RAM access methods), thus providing persistent management of the objects' properties (location, attributes).

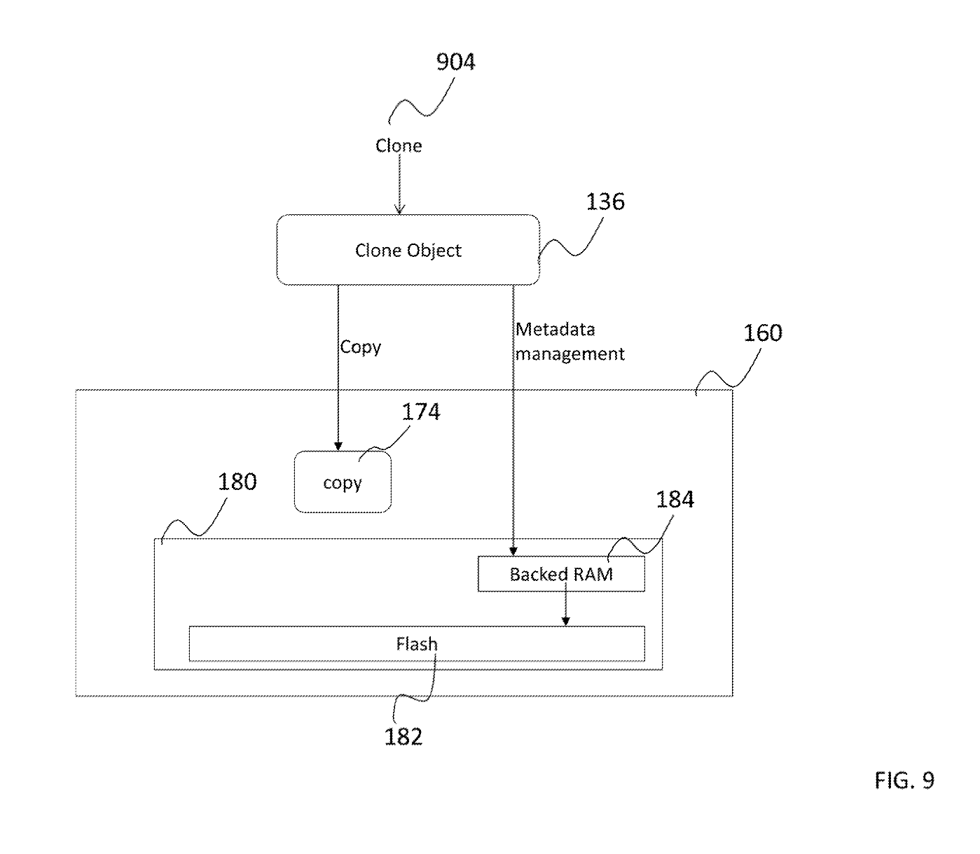

As represented in FIG. 9, the “clone object” module 136 provides object copy functionality. Such functionality can be used for Virtual Machine or virtual volume functionality, for example, internal cloning of a virtual machine or virtual disk. According to a nonlimiting aspect of the invention, the clone object module 136 receives a clone directive 904 from the host system 200 (with optional data). The clone object module 136 uses the copy primitive 174 to copy from a source address to a destination address in a storage device 160.

In view of the above, it is believed that replacing storage media in servers and storage applications alone wastes many advantages of flash technology inherent from the differences between the technologies. For example, HDD devices employ mechanical and relatively large elements of rotating disks. In contrast, flash media reside on small electronic components soldered directly to printed circuit boards, therefore requiring no external packaging or hardware. Additionally, flash-based SSDs also use different electrical interfaces and data transfer protocol (software protocol interface). Hence, flash-based storage devices can be designed using PCI Express (PCIe) adapter cards where the PCIe multi-lane interface provides lower latency and higher bandwidth, replacing current SATA (Serial ATA) and SAS (Serial Attached SCSI) serial cable interfaces. Also, new protocols such as NVM-Express are replacing the old ATA and SCSI based protocols. In view of these differences, it is believed that the above-described system can greatly improved functionality of host systems, such as servers and storage applications, by providing an efficient, systemwide storage method.

While the invention has been described in terms of specific embodiments, it is apparent that other forms could be adopted by one skilled in the art. For example, the physical configuration of the hardware or system could differ from that shown. Therefore, the scope of the invention is to be limited only by the following claims.

1. A system comprising a mass storage device connected to a host computer running host software modules, the mass storage device comprising:
at least one non-volatile memory device, at least one volatile memory device, and a memory controller attached to the non-volatile and volatile memory devices, the memory controller being connected to the host computer via a computer bus interface; and
firmware executing on the memory controller to provide software primitive functions, a software protocol interface, and an application programming interface to the host computer;
wherein the host software modules run by the host computer access the software primitives functions and the application programming interface of the mass storage device.

2. The system of claim 1, wherein the non-volatile memory is a flash-based memory and the volatile memory is DRAM memory.

3. The system of claim 1, wherein the computer bus interface is an interface according to the PCI Express bus standard.

4. The system of claim 1, wherein at least part of the volatile memory is a persistent memory that backups data to an area allocated in the non-volatile memory using an auxiliary backup power source in the event of main power loss, and restores the data from the area allocated in the non-volatile memory to the volatile memory in the event of main power restoration.

5. The system of claim 1, wherein the software protocol interface is chosen from the group consisting of SATA, SCSI, or NVM Express storage protocol standards.

6. The system of claim 1, wherein the non-volatile memory and the volatile memory are written simultaneously in a SCSI command in a single SCSI cycle.

7. The system of claim 1, wherein the firmware provides an application programming interface to move a data segment from a first memory location in the mass storage device to a second location in the mass storage device and then write a data segment to the first location with a single input/output instruction.

8. The system of claim 1, wherein the firmware provides an application programming interface to sets a fixed value to a memory location in the mass storage device.

9. The system of claim 1, wherein a host software module uses the firmware primitives and the volatile memory to enable taking a snapshot of a disk or a file, wherein production data, snapshot data, and data copied with the firmware primitives are stored in the mass storage device and metadata corresponding to the snapshot are stored in the volatile memory.

10. The system of claim 1, wherein a host software module uses the firmware primitives and the volatile memory to provide storage journaling functions and metadata corresponding to the journaling functions are stored in the volatile memory.

11. The system of claim 1, wherein a host software module creates virtual machines by using a reset firmware primitive to set fixed values in the virtual machine's object address.

12. The system of claim 1, wherein a host software module clones virtual machines by using a copy firmware primitive to copy data from one virtual machine's object address to another virtual machine's object address.

13. The system of claim 1, wherein the host software modules access the software primitive functions and the application programming interface of the mass storage device to provide storage functions, and metadata corresponding to the storage functions are maintained and managed in the volatile memory.

14. The system of claim 1, wherein the host software modules sends metadata along with data when transferring data to the mass storage device by piggybacking the metadata on the data.

15. The system of claim 1, wherein the host software modules are part of a software development kit.

16. A method performed with a system comprising a mass storage device connected to a host computer running host software modules, the mass storage device comprising at least one non-volatile memory device, at least one volatile memory device, and a memory controller attached to the non-volatile and volatile memory devices, the memory controller being connected to the host computer via a computer bus interface, the method comprising:
executing firmware on the memory controller to provide software primitive functions, a software protocol interface, and an application programming interface to the host computer; and
running the host software modules to access the software primitives functions and the application programming interface of the mass storage device.

17. The method of claim 16, further comprising accessing the software primitive functions and the application programming interface of the mass storage device with the host software modules to provide storage functions, and maintaining and managing metadata corresponding to the storage functions in the volatile memory.

18. The method of claim 16, further comprising piggybacking metadata on data when transferring data to the mass storage device.
